(19) United States
(12) Patent Application Publication
(10) Pub. No.: US 2003/0182202 A1
(43) Pub. Date: Sep. 25, 2003

(54) Method and system for conducting royalty transactions

(75) Inventor: Stuart Eason, Victoria (AU)

Correspondence Address: OPPENHEIMER WOLFF & DONNELLY LLP, 840 NEWPORT CENTER DRIVE, SUITE 700, NEWPORT BEACH, CA, 92660, US

(73) Assignee: Norwood Industries Pty Ltd

(21) Appl. No.: 10/341,905

(22) Filed: Jan. 13, 2003

(30) Foreign Application Priority Data
Jan. 15, 2002 (AU) PR9966

(51) Int. Cl. G06G 1/14

(52) U.S. Cl. 705/26; 705/28; 705/22

(57) ABSTRACT

This invention relates generally to transactions, and more particularly to transactions relating to a product which is directly or indirectly associated with a royalty. The invention relates to a method and system for conducting and managing royalty transactions conducted between a royalty owner 1-3 of one or more varieties of royalty products and one or more vendors 4-9 of the product. Each product sold includes a label which is distinctive for each variety of royalty product. The system allows the owner 1-3 to manage the transactions associated with the royalty product in real time through the use of an administration computer 12, administration database and a computer network 13.

This invention relates generally to transactions, and more particularly to transactions relating to a product which is directly or indirectly associated with a royalty. The invention has a particular, but non-exclusive application in relation to royalty products of a horticultural nature. It should be appreciated however that the invention may also be suitable for use with any other product for which a royalty applies.

A royalty is normally payable by a user to the owner of the right for the use of that right. In some situations the owner of the right provides the user with a royalty product. Alternatively, the owner merely provides the right to use, and it is the responsibility of the user to produce the product. In relation to the particular application of horticultural products, the rights normally include Plant Breeders' Rights and registered or unregistered Trade Mark Rights. The owner of the Plant Breeders Rights may provide the user or a vendor with the plant or may permit the vendor to propagate the plant. The owner of the trade mark rights may provide a plant along with permission to use the trade mark or may only provide the vendor with permission to use the trade mark. As the owner does not always provide the vendor with the plant, normal accounting procedures, such as counting the plants supplied, do not apply. Accordingly, the owner normally has to rely upon the honesty of the vendor to accurately audit the number of royalty products sold.

It would be desirable to develop a method for conducting transactions in relation to royalty products that did not rely upon an audit of the vendor. It would also be desirable to develop a method and system by which the owner could easily manage these transactions.

For the purpose of this specification the term Royalty Owner includes the owner of the right, and any one licensed by the owner of the right to control those rights as if they were the owner, including granting vendors the right to use the owner's rights.

According to a first aspect of this invention there is provided a method of conducting transactions between a royalty owner of one or more varieties of royalty products and one or more vendors of the products, where each royalty product sold by the vendors is supplied with a label which is distinctive for each variety of royalty product. The method requires a royalty value to be set for each distinctive label, the vendor charged a royalty charge based on the quantity of labels supplied and the royalty value for each label, and collecting the royalties charged.

This invention applies to, and for the purpose of this specification it is to be understood that the labels may be distinctive for a plurality of varieties of products or distinctive for a single variety of a product. More specifically, in relation to the preferred application, in horticultural products the label may be distinctive for a plurality of different varieties of plant, or distinctive for a single variety of plant.

It should be appreciated that by conducting the transactions in this method, without relying on an audit of the vendor, the owner will have a greater level of comfort that an appropriate royalty has been charged and collected.

It is preferred that the method be administered by a system administrator. The system administrator may be independent of the royalty owner, however this is not essential. It is preferred that the vendor order labels from the system administrator and that the system administrator supply the ordered labels on instructions from the royalty owner. In this regard it is preferred that the administrator manufacture the labels, however this is not essential.

Labels may be stockpiled to meet expected demand however this is not essential. The royalty owner may set minimum and/or maximum safety levels for the labels stockpiled. The minimum safety level may be set at any quantity considered appropriate to meet a demand for the labels over a period. Any period duration may be adopted however it is preferred that the period duration be a quarter of a year. The minimum safety level may be fixed for the period, or varied-over that period depending upon the projected demand being either constant or variable for that period. The minimum safety level may be manually set at a quantity considered appropriate or may be automatically set based on past demand for the label. Any automatic setting may be adopted, however where historical quarterly data is available 80% of quarterly demand for that quarter of the previous year may be considered appropriate. It should be appreciated that the percentage is variable.

Any maximum safety level may be adopted. The preferred maximum safety level is the combination of the minimum safety level and a maximum print run order set by the royalty owner. The factors effecting the maximum print run order include the economics of ordering larger quantities from the manufacturer, the financial responsibility for the labels in the event they are not required by the vendors. An appropriate maximum safety level may be one third of the annual turnover of labels.

The labels are preferably stockpiled by the system administrator. Where the system administrator is also the manufacturer for the labels the system administrator may elect to stockpile more labels than the maximum safety level.

It is preferred that the owner set the royalty value for each distinctive label. The royalty value may vary between vendors, however this is not essential. The royalty value may be set at any value, including zero. The royalty value may vary over time or for other reasons including vendor performances

It is preferred that the system administrator collect the royalties charged and remit the collected royalties to the owner at specific intervals. Any interval will be suitable, however, a six month interval is preferred. It is further preferred that the vendor be reimbursed royalties collected, or royalties charged, where labels are returned to the administrator.

The method may also include an administration charge charged to the royalty owner by the system administrator, however this is not essential. The administration charge may be calculated in any suitable manner and may include any one or more of the following: a flat charge, an annual charge and or a stockpile charge relating to the quantity of labels stockpiled.

According to another aspect of this invention there is provided a method of managing transactions conducted between a royalty owner of one or more varieties of royalty products and one or more vendors of the products. Each product sold includes a label which is distinct for each variety of product, the method including:

a system administrator provides and maintains an administration computer hosting an administration database, the royalty owner being linkable to the administration computer via a computer network;

royalty value data corresponding to a royalty value for each distinctive label is entered into the administration database;

quantity supplied data corresponding to the quantity of each distinctive label supplied to each vendor is entered into the administration database;

royalty charged data corresponding to the royalty value data multiplied by the quantity supplied data is calculated by the administration computer and retained by the administration database;

royalty collected data corresponding to the royalties collected from the vendor is entered into the administration database; wherein

the owner controls the supply of labels to each vendor based on the data on the administration database.

It is further preferred that the administration computer compares the royalty charged data with the royalty collected data and calculates royalty uncollected data which is retained by the administration database.

It is preferred that the administration computer includes a date reference against which royalty value, quantity supplied, royalty charged, royalty collected and royalty uncollected data is compiled. The owner may select a date range over which to view the data on the administration database. This allows the owner to manipulate the data in a manner which facilitates identifying trends in the data.

It is preferred that the royalty value, quantity supplied, royalty charged, royalty collected and royalty uncollected data be compiled with reference to each distinctive label and/or with reference to each vendor. It is preferred that the vendor reference include a territorial indicator. The data on the administration database may be viewed in summary with reference to the territorial indication only. It is further preferred that the data be viewed in detail with reference to both the territorial indicator and the label reference, or the vendor reference. Any label reference would be appropriate, however where the royalty product is plants it is preferred that the label reference include at least the variety name of the plant. Any vendor reference would be appropriate, however it is preferred that the vendor reference be the personal name, business name or company name of the vendor. Any territorial indicator would be appropriate, however, it is preferred that the territorial indicator include a reference to the state, country or continent within which the vendor is located.

It is preferred that the labels be supplied to the vendors by the system administrator. The system administrator may manufacture the labels however this is not essential. Labels may be stockpiled to meet expected demand. In this regard it is preferred that the method include entering stock data onto the administration database. It is preferred that the stock data include on hand which relates to the number of labels on hand, on order which relates to the number of labels which have been ordered by vendors and work in progress relating to the quantity of labels being manufactured. The administration computer preferably deducts the on order quantity from the on hand quantity to calculate an available quantity of labels being available to be supplied to vendors. The administration computer also preferably adds the work in progress to the available quantity to calculate a projected quantity corresponding to a quantity of labels which may be supplied to vendors in the near future.

The royalty owner may set minimum and/or maximum safety levels for the labels stockpiled. The minimum safety level may be set at any quantity considered appropriate to meet a demand for the labels over a period. Any period duration may be adopted however it is preferred that the period duration be a quarter of a year. The minimum safety level may be fixed for the period, or varied over that period depending upon the projected demand being either constant or variable for that period. The minimum safety level may be manually set at a quantity considered appropriate or may be automatically set based on past demand for the label. Any automatic setting may be adopted, however where historical quarterly data is available 80% of quarterly demand for that quarter of the previous year may be considered appropriate. It should be appreciated that the percentage is variable.

Any maximum safety level may be adopted. The preferred maximum safety level is the combination of the minimum safety level and a maximum print run order set by the royalty owner. The factors effecting the maximum print run order include the economics of ordering larger quantities from the manufacturer, the financial responsibility for the labels in the event they are not required by the vendors. An appropriate maximum safety level may be one third of the annual turnover of labels.

The method may also include an administration charge charged to the royalty owner by the system administrator, however this is not essential. The administration charge may be calculated in any suitable manner and may include any one or more of the following: a flat charge, annual charge, an access charge for each time the administration computer is accessed and/or the charge may relate to the quantity of labels stockpiled.

It is preferred that the royalty owner set the royalty value for each distinctive label. The royalty owner may vary the royalty value for each distinctive label relative to each vendor such that the royalty value for one distinctive label may vary between vendors however this is not essential. The royalty value may be set at any value, including zero.

The supply of labels to the vendors may be selective such that the royalty owner selects which vendors are to be supplied with which varieties of distinctive labels, however this is not essential. Instead all labels may be available to all vendors.

It is preferred that the computer network is the internet and the administration computer is an internet server and wherein the royalty owner operates a computer or other digital communication device which is connected either permanently or on an intermittent basis to the administration computer via the internet.

It is preferred that the royalty owner set a read only password which permits a person entering that password to view all information on the database.

The royalty owner may instruct the system administrator to enter the royalty value, minimum safety level, maximum safety level and label supply selections on the administration database, however it is preferred that the royalty owner enter these directly via the computer network. In this regard it is preferred that the owner set a read and write password which permits a person entering that password to view all information on the database and enter the owner selections.

The owner may wish to show selected information to selected persons. In this regard it is preferred that the owner set a show only password which permits a selected person entering that password to view selected information on the database.

According to further still another aspect of this invention, there is provided a system of managing transactions conducted between a royalty owner of one or more varieties of royalty products and one or more vendors of the product. Each product sold includes a label which is distinct for each variety of royalty product, the system including:

an administration computer maintained by a system administrator;

an administration database provided on the administration computer for retaining data including:

royalty value data corresponding to a royalty value for each distinctive label is entered into the administration database;

quantity supplied data corresponding to the quantity of each distinctive label supplied to each vendor is entered into the administration database;

royalty charged data corresponding to the royalty value data multiplied by the quantity supplied data is calculated by the administration computer and presented on the administration;

royalty collected data corresponding to the royalties collected from the vendor is entered into the administration database; wherein

data entry software running on the administration computer for entering the data into the database;

computation software running on the administration computer for producing calculated data for the administration database;

a computer network linking the royalty owner to the administration computer,

wherein the royalty owner access the administration computer to view the data on the administration database and controls the supply of labels to each vendor based on the data on the administration database.

It is preferred that the computer network is the internet and the administration computer is an internet server and wherein the royalty owner operates a computer or other digital communication device which is connected either permanently or on an intermittent basis to the administration computer via the internet.

It is preferred that access to the administration computer be controlled by one or more passwords. In this regard it is preferred that the owner set a read only password which permits a person entering that password to view all information on the database.

The royalty owner may instruct the system administrator to enter the royalty value, safety level and label supply selections on the database, however it is preferred that the royalty owner enter these details directly via the computer network. The system may also include owner entry software running on the owner's computer or other digital communication device for entering data directly onto the administration computer. In this regard it is preferred that the royalty owner set a read and write password which permits a person entering that password to view all information on the database and alter the owner selections.

The royalty owner may wish to show selected information to selected persons. In this regard it is preferred that the royalty owner set a view only password which permits a selected person entering that password to view selected information on the database.

It is preferred that the system include software to view or download the data on the administration database in a spreadsheet (TAB) or Acrobat® (PDF) format. Other formats may also be appropriate.

It should be appreciated that this method and system according to the second and third aspects of the invention allows the owner to manage the transactions associated with the royalty product in real time, which facilitates an efficient management of the owner's rights.

The invention will be hereinafter described in greater detail by reference to the accompanying illustrations which relate to the various aspects of this invention. It is to be understood that the particularity of the illustrations does not supersede the generally of the definition of the invention as defined by the claims.

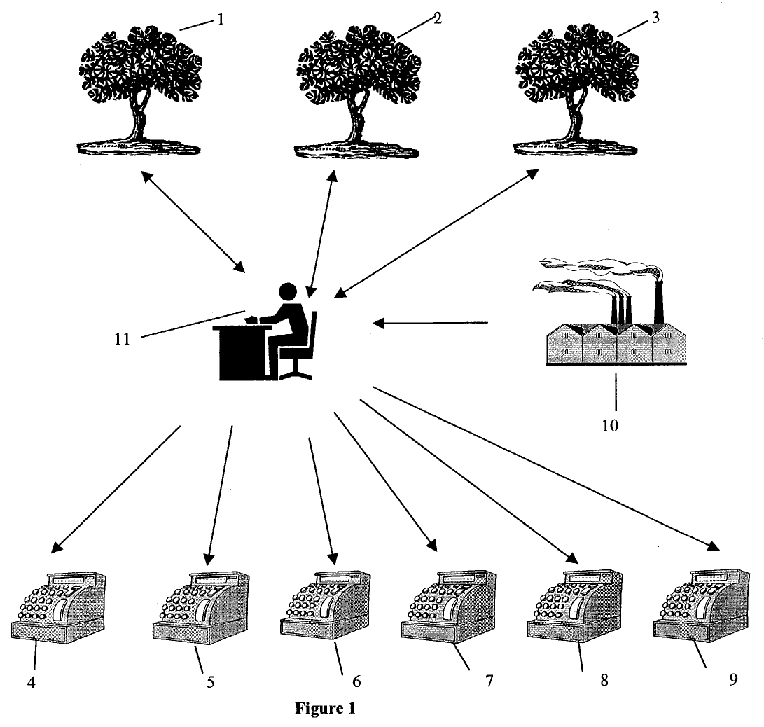

FIG. 1 is a schematic flow diagram of a first aspect of the invention.

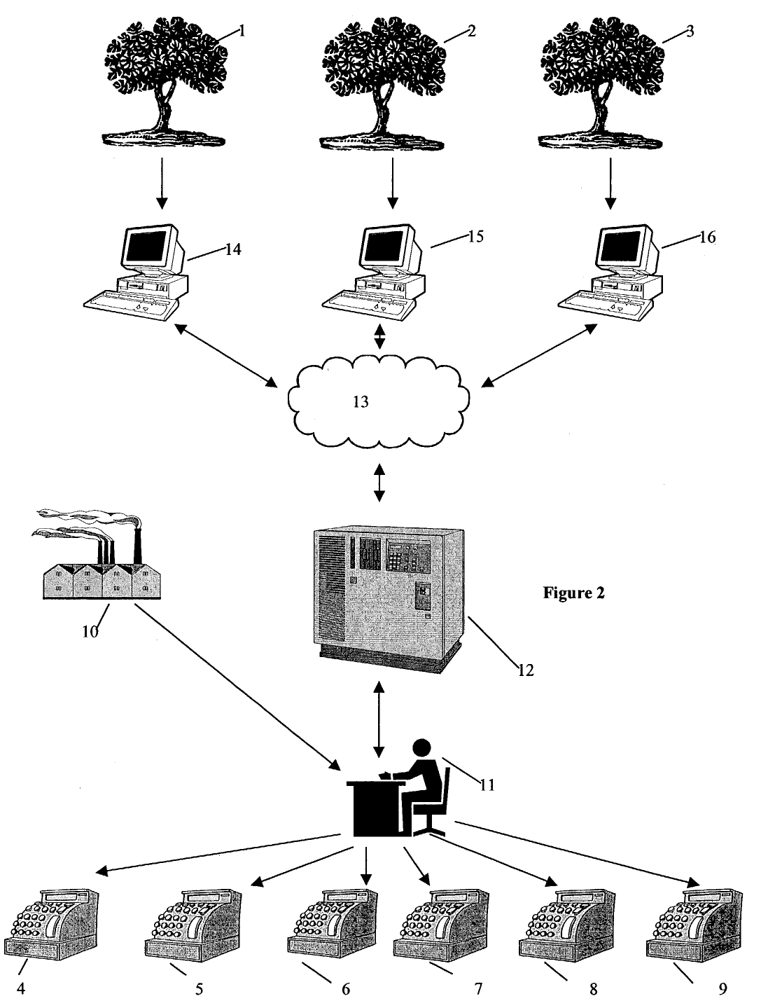

FIG. 2 is a schematic flow diagram of a second aspect of the invention.

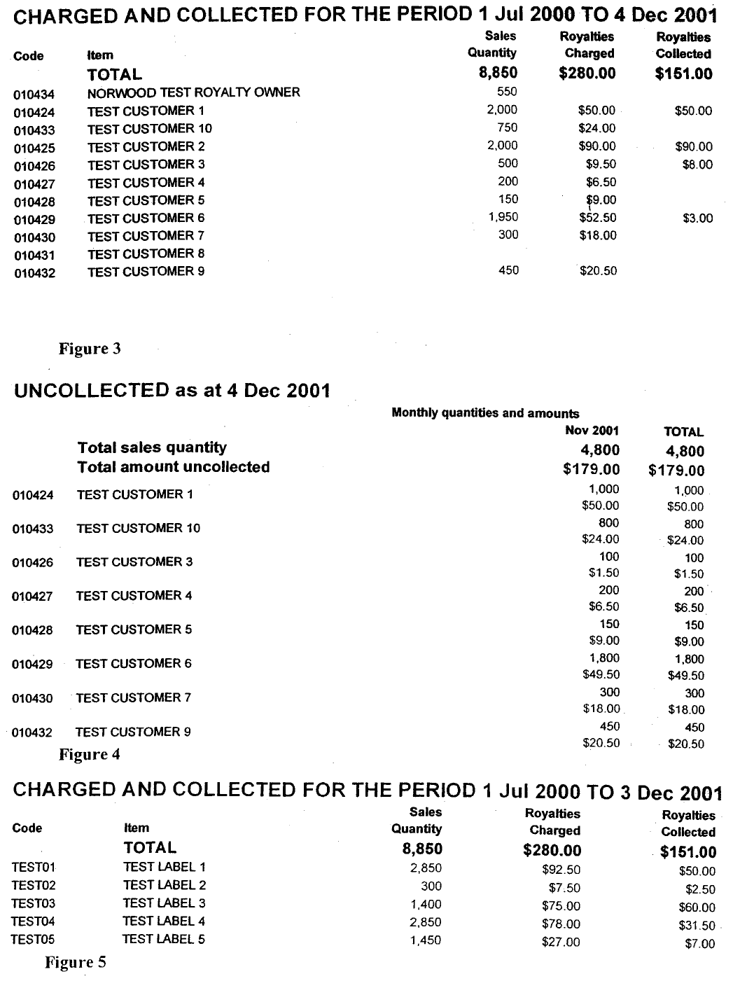

FIGS. 3 to 7 illustrate sample data from the administration database.

Referring firstly to FIG. 1, the illustration shows in schematic form a flow diagram of the method of conducting transactions between a plurality of royalty owners 1, 2, 3 of one or more varieties of royalty products, and a plurality of vendors 4 to 9 of the products. Whilst the royalty owners 1-3 are illustrated in the form of a tree, and the invention is particularly suitable for horticultural products, it should be appreciated that the invention is also suitable for non-horticultural products where royalties apply.

The method relies upon each royalty product sold by the vendor being supplied with a label which is distinctive for each variety of royalty product. This label is produced by a manufacturer 10 who may or may not be independent of a system administrator 11 who administers the method.

In an example method according to the invention, a royalty value is set for each distinctive label and the vendor is charged a royalty charge based on the quantity of labels supplied and the royalty value for each label supplied. The royalty value for each label is normally set by the royalty owner, however the royalty owner may seek advice from the system administrator as to an appropriate royalty value. The royalty value may be set at any value. This value may be zero, particularly where the royalty owner is trying to win the vendor as a client, whereby the vendor may be charged a royalty in the future.

The system administrator then collects the royalties charged and remits the collected royalties to the owner at specific intervals. Any interval would be suitable and may vary according to the preference of the royalty owner or system administrator.

Where labels are returned to the system administrator, the vendor is to be reimbursed the royalties collected or royalties charged. This may involve the vendor being provided with a reimbursement cheque, or alternatively the vendor's account may be credited a value equivalent to the reimbursement.

The method relies on labels being available to accompany the royalty product sold by the vendors. In this regard, labels may be stockpiled to meet expected demand for a period. The stockpile may have a minimum and/or maximum safety level which may be set by the royalty owner or the system administrator. The minimum safety level may be fixed for the period or varied over that period depending upon the projected demand being either constant or variable for that period. Setting the minimum safety level at 80% of the quarterly demand from the equivalent quarter from last year may be appropriate. It should be appreciated that the percentage is adjustable.

The maximum safety level is the combination of the minimum safety level and a maximum print run order for the manufacturer of the labels set by the royalty owner. The factors affecting the maximum print run order include the economies of ordering larger quantities from the manufacturer, balanced against the financial responsibility for the labels in the event that they are not required by the vendors. In this regard, an appropriate maximum safety level may be one third of the annual turnover of the labels. Naturally, where the system administrator is also the manufacturer of the labels, the system administrator may elect to stockpile more labels than the maximum safety level set by the royalty owner.

The royalty owner may be charged an administration charge by the system administrator. The charge may be a flat charge, an annual charge or a stockpile charge relating to the quantity of labels stockpiled.

In accordance with another aspect of this invention there is provided a system and method of managing transactions conducted between a royalty owner 1-3 of one or more varieties of royalty products and one or more vendors 4-9 of the products. A schematic flow diagram of the system is illustrated in FIG. 2 where like reference numerals are used to refer the same features from the method according to the first aspect of this invention.

Referring now to FIG. 2, the system administrator 11 maintains an administration computer 12 which is hosts an administration database. The system administrator 11 administers the method of conducting transactions between the royalty owners 1-3 and the vendors 4-9 as described with reference to the first aspect of this invention. The administration database retains information regarding the royalty value set for each distinctive label, and the quantity of each distinctive label supplied to each vendor. The administration computer 12 calculates the royalty charged data, and retains information regarding the method of conducting transactions which includes the royalty collected from the vendors resulting from the royalty charged. The administration computer 12 may also calculate the royalties uncollected by subtracting the royalties collected from the royalties charged. The royalty owners are linkable to the administration computer 12 via a computer network 13. In this particular example embodiment, the computer network is the internet, and the administration computer is an internet server.

The example illustrated has the royalty owners accessing the internet via personal computer 14-16, however the royalty owners may use other digital communication devices.

The administration computer includes a date reference against which the royalty value, quantity supplied, royalty charged, royalty collected and royalty uncollected data is compiled. The royalty value, quantity supplied, royalty charged, royalty collected and royalty uncollected data is also compiled with reference to each distinctive label and/or reference to each vendor. The vendor reference includes a territorial indicator. When the royalty owner accesses the administration database they can manipulate the data with these references to assess the performance of their royalty products. Other reference and indicators could clearly be included.

Access to the administration computer is to be controlled by one or more passwords. In particular, access over the internet is controlled by a read only password which is set by the owner and which permits a person entering that password to view all the information on the database. This allows the owner to view the quantity supplied data, royalties collected data for each vendor as shown in FIG. 3, and more specifically the royalties uncollected data for each customer as shown in FIG. 4 and control the supply of labels to each vendor based on this data. More specifically, where the royalty owner notices a particular vendor is not forthcoming with remittance of royalties charged to the system administrator, the royalty owner may stop the supply of labels to that customer.

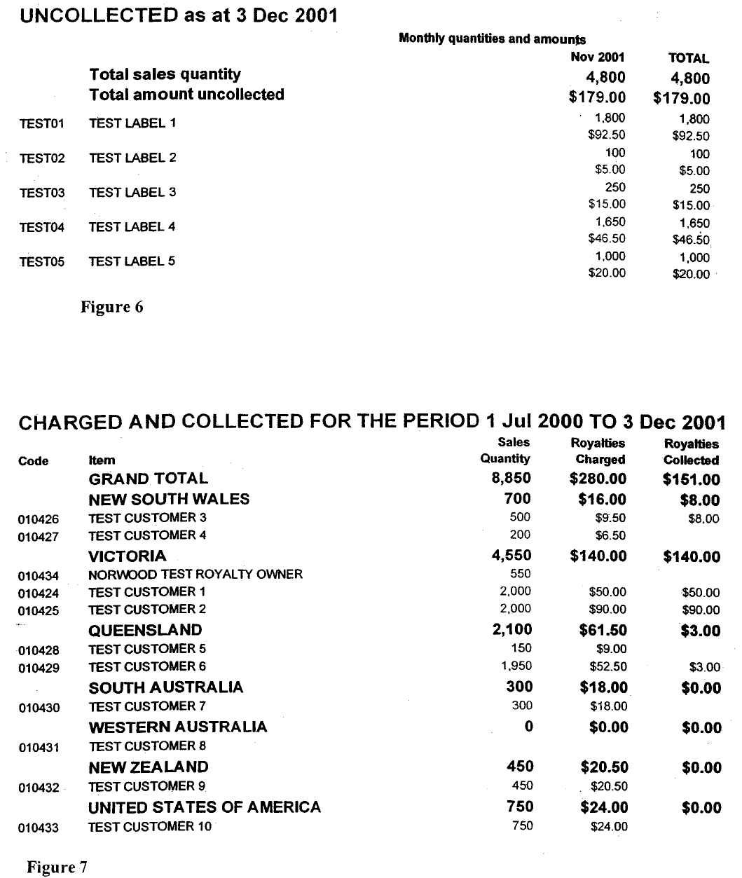

Submitting the correct read only password to the administration computer allows the royalty owner to also view the quantity supplied, royalty charged, royalty collected, and royalty uncollected by reference to the label itself as show in FIGS. 5 and 6. The royalty owner may use this information in any way suitable. For example, the information may represent that a particular style of label is not attractive to the purchasing public, and by changing the label the royalty owner may notice an improvement in demand for that royalty product.

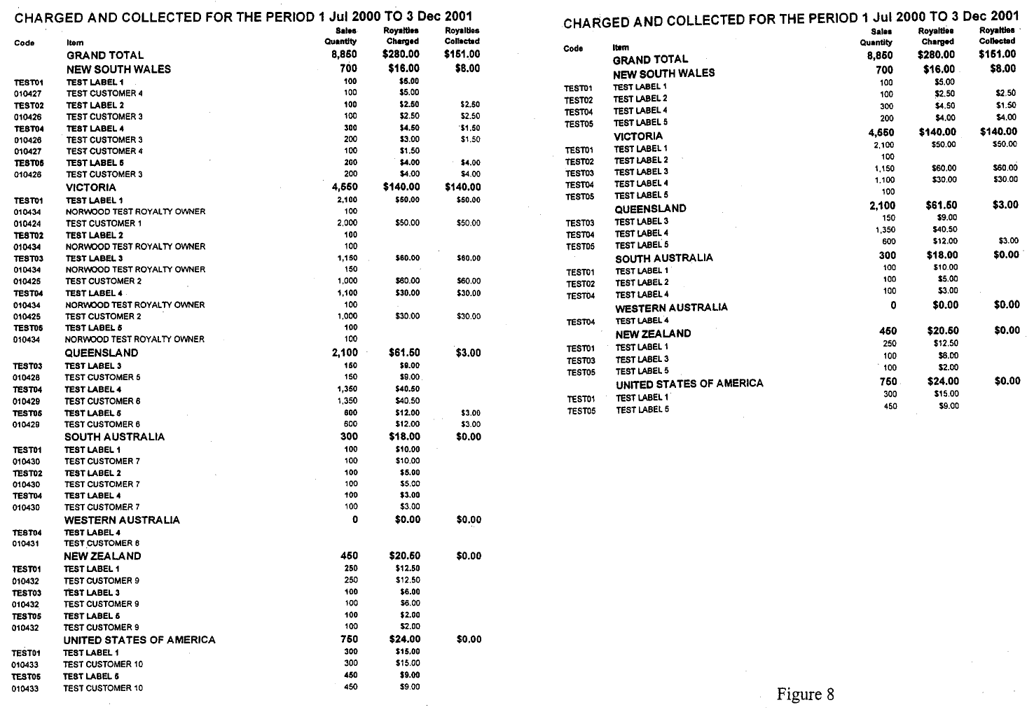

Furthermore, submitting the correct read only password to the administration computer allows the royalty owner to view the quantity supplied, royalty charged and royalty collected by reference to the geographical indicator of each customer. This can be viewed in summary, as shown in FIG. 7, or in detail with reference to each label supplied to the vendors as shown in FIG. 8. The royalty uncollected data (not shown) may also be viewed in this manner.

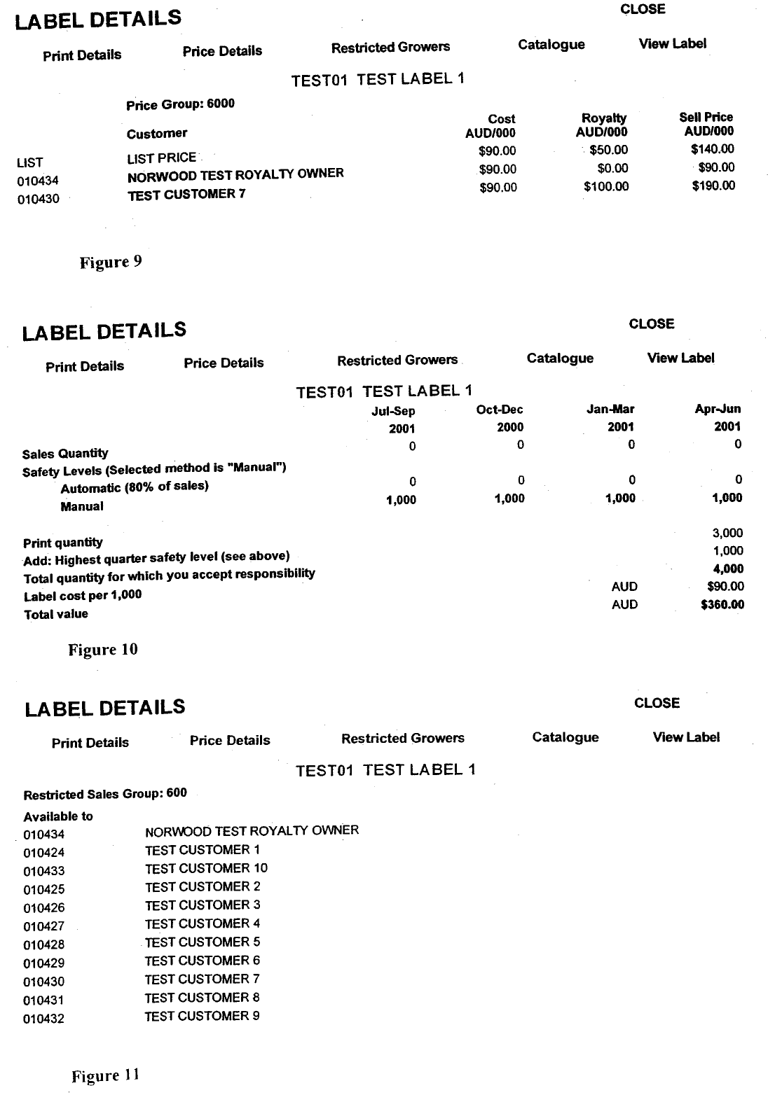

The system according to the invention allows for the system administrator to enter the royalty value, maximum and minimum safety levels and label supply selections on the administration database. The system may also allow for the royalty owner to enter the royalty value, safety level and label supply selections directly via the internet. In this example, the system includes owner entry software running on the owner's computer for entering data directly onto the administration computer. A read and write password is set which permits a person entering that password to view all information on the database and to alter the royalty value, safety levels and label supply selections on the administration database, as shown in FIGS. 9, 10 and 11. For example, referring to FIG. 9, test customer 7 pays a royalty value of $100 per 1000 labels supplied. With the owner entry software, the royalty owner can amend this royalty value on line. Furthermore, referring to FIG. 10, test label 1 has a safety level manually set at 1000 labels per quarter. With the owner entry software the royalty owner could alter this manual setting, or switch the safety level to the automatic setting of 80% of the highest quarterly demand. Also, the royalty owner could amend the maximum safety level by altering the print quantity directly on line. Still furthermore, referring now to FIG. 11, in the even that test customer 1 is not being forthcoming with remitting royalties charged on time, using the owner entry software, the royalty owner could exclude test customer 1 to access to test label 1. It should be appreciated that the read only password permits FIGS. 7, 8 and 9 to be viewed but not altered.

The royalty owner may wish to show selected information to selected persons. In particular, where the royalty owner is a licensee of the owner of the right, the owner of the right may wish to have access to information regarding that particular royalty product. Accordingly, the system allows the setting of a view only passwords which permits a selected person entering that password to view the selected information on the database. More specifically in relation to this example, the royalty owner may have a licence to produce a product under test label 1 and the owner of that right may wish to view the performance of test label 1. In this regard, upon entering the view only password the owner can have access to information regarding test label 1.

This system may involve charging in addition to the administration charge a charge per view payable as a result of accessing the administration database. It will be apparent from the foregoing description that the present invention provides a simple yet effective method of conducting transactions in relation to royalty products, and a method and system for managing these transactions. The ability to manage the transactions on line is a particular advantage.

Finally, it is to be understood that various alterations, modifications and/or additions may be introduced into the methods and system as previously described without departing from the spirit or ambit of the invention as defined by the claims.

Having now described our invention, what we claim as new and desire to secure by Letters Patent is:

1. A method of conducting transactions between a royalty owner of one or more varieties of royalty products and one or more vendors of the products, where each royalty product sold by the vendors is supplied with a label which is distinctive for each variety of royalty product, the method including:
setting a royalty value for each distinctive label;
charging the vendor a royalty charge based on the quantity of labels supplied and the royalty value for each label; and
collecting the royalties charged.

2. A method according to claim 1, wherein the method is administered by a system administrator.

3. A method according to claim 2, wherein the system administrator is independent of the royalty owner.

4. A method according claim 2, wherein the vendor orders labels from the system administrator and the system administrator supplies the ordered labels to the vendors on instructions from the royalty owner.

5. A method according to claim 2, wherein the system administrator manufactures the labels.

6. A method according to any one of claims 2 to 5 including stockpiling of labels to meet expected demand wherein the royal owner sets minimum and/or maximum safety levels for the labels stockpiled.

7. A method according to claim 6, wherein the minimum safety level is constant for a selected period.

8. A method according to claim 6, wherein the minimum safety level is variable for a selected period.

9. A method according to claim 8, wherein the minimum safety level varies quarterly for a selected period of a year the minimum safety level being 80% of quarterly demand for the label for the corresponding quarter of a previous year.

10. A method according to claim 6, wherein the maximum safety level is the combination of a minimum safety level and a maximum print run order set by the royalty owner.

11. A method according to claim 10, wherein the maximum safety level for a quarter is one third of the previous annual turnover of labels.

12. A method according to any one of the preceding claims wherein the royalty value for each distinctive label is set by the royalty owner.

13. A method according to claim 12, wherein the royalty value for a specific label varies between vendors.

14. A method according to claim 12, wherein the royalty value is set at zero.

15. A method according to claim 2, wherein the system administrator collects the royalties charged and remits the collected royalties to the royalty owner at specific intervals.

16. A method according to claim 15, wherein the vendor is reimbursed royalties charged or royalties collected where unused labels are returned to the system administrator.

17. A method according to claim 2, including an administration charge charged to the royalty owner by the system administrator, the administration charge being calculated by any one of the following:
a flat charge;
an annual charge; and/or
a stockpile charge relating to a quantity of labels stockpiled by the system administrator.

18. A method of managing transactions conducted between a royalty owner of one or more varieties of royalty products and one or more vendors of the products, each product sold includes a label which is distinct for each variety of product, the method including:
a system administrator provides and maintains an administration computer hosting an administration database, the royalty owner being linkable to the administration computer via a computer network;
royalty value data corresponding to a royalty value for each distinctive label is entered into the administration database;
quantity supplied data corresponding to the quantity of each distinctive label supplied to each vendor is entered into the administration database;
royalty charged data corresponding to the royalty value data multiplied by the quantity supplied data is calculated by the administration computer and retained by the administration database;
royalty collected data corresponding to the royalties collected from the vendor is entered into the administration database; wherein
the owner controls the supply of labels to each vendor based on the data on the administration database.

19. A method according to claim 18, wherein the administration computer compares the royalty charged data with the royalty collected data and calculates royalty uncollected data which is retained by the administration database.

20. A method according to claim 19, wherein the administration computer includes a date reference against which the royalty value, quantity supplied, royalty charged, royalty collected and royalty uncollected data is compiled.

21. A method according to claim 19 or 20, including compiling the royalty value, quantity supplied, royalty charged, royalty collected and royalty uncollected data with reference to each distinctive label.

22. A method according to claim 19 or 20, including compiling the royalty value, quantity supplied, royalty charged, royalty collected and royalty uncollected data with reference to each vendor.

23. A method according to claim 22, wherein the vendor reference includes a territorial indicator selected from any one of the following: state, country or continent within which the vendor is located.

24. A method according to any one of claims 18 to 23. including entering stock data onto the administration database which includes labels on hand relating to the number of labels available, labels on order which relates to the number of labels which have been ordered by vendors and work in progress relating to the quantity of labels being manufactured.

25. A method according to claim 24, wherein the administration computer deducts the on order quantity from the on hand quantity to calculate an available quantity of labels being available to be supplied to vendors.

26. A method according to claim 25, wherein the administration computer adds the work in progress to the available quantity to calculate a projected quantity corresponding to a quantity of labels which may be supplied to vendors in the near future.

27. A method according to any one of claims 18 to 26, wherein the system administrator supplies the labels to the vendors, wherein the system administrator stockpiles the labels to meet expected demand.

28. A method according to claim 27 wherein the royal owner sets minimum and/or maximum safety levels for the labels stockpiled.

29. A method according to claim 28, wherein the minimum safety level is constant for a selected period.

30. A method according to claim 28, wherein the minimum safety level is variable for a selected period.

31. A method according to claim 30, wherein the minimum safety level varies quarterly for a selected period of a year, the minimum safety level being 80% of quarterly demand for the label for the corresponding quarter of a previous year.

32. A method according to claim 28, wherein the maximum safety level is the combination of a minimum safety level and a maximum print run order set by the royalty owner.

33. A method according to claim 32, wherein the maximum safety level for a quarter is one third of the previous annual turnover of labels.

34. A method according to any one of the preceding claims wherein the royalty value for each distinctive label is set by the royalty owner.

35. A method according to claim 34, wherein the royalty value for a specific label varies between vendors.

36. A method according to claim 34, wherein the royalty value is set at zero.

37. A method according to any one of claims 18 to 36, wherein the system administrator collects the royalties charged and remits the collected royalties to the royalty owner at specific intervals.

38. A method according to claim 37, wherein the vendor is reimbursed royalties charged or royalties collected where unused labels are returned to the system administrator.

39. A method according to any one of claims 18 to 38, including an administration charge charged to the royalty owner by the system administrator, the administration charge being calculated any one of the following:
a flat charge;
an annual charge; and/or
a stockpile charge relating to a quantity of labels stockpiled by the system administrator.

40. A system of managing transactions conducted between a royalty owner of one or more varieties of royalty products and one or more vendors of the product, each product sold including a label which is distinct for each variety of royalty product, the system including:
an administration computer maintained by a system administrator;
an administration database provided on the administration computer for retaining data including:
royalty value data corresponding to a royalty value for each distinctive label is entered into the administration database;
quantity supplied data corresponding to the quantity of each distinctive label supplied to each vendor is entered into the administration database;
royalty charged data corresponding to the royalty value data multiplied by the quantity supplied data is calculated by the administration computer and presented on the administration;
royalty collected data corresponding to the royalties collected from the vendor is entered into the administration database; wherein
data entry software running on the administration computer for entering the data into the database;
computation software running on the administration computer for producing calculated data for the administration database;
a computer network linking the royalty owner to the administration computer,
wherein the royalty owner access the administration computer to view the data on the administration database and controls the supply of labels to each vendor based on the data on the administration database.

41. A system according to claim 40, wherein the computer network is the internet and the administration computer is an internet server, and wherein the royalty owner operates a computer or other digital communication device which is connected either permanently or on an intermittent basis to the administration computer via the internet.

42. A system according to claims 40 or 41, wherein access to the administration computer is controlled by one or more passwords.

43. A system according to claim 42, wherein the owner sets a read only passwords which permits a person entering that password to view all information on the database.

44. A system according to any one of claims 40 to 43, wherein the royalty owner instructs the system administrator to enter the royalty value, safety value and label supply selection into the data base.

45. A system according to any one of claims 40 to 43, wherein the royalty owner enters the royalty value, safety level and label supply selections into the database directly via the computer network.

46. A system according to claim 45, including owner entry software running on the owner's computer or other digital communication device for entering data directly into the administration computer.

47. A system according to claim 46, wherein the royalty owner sets a read and write password which permits a person entering that password to view all information on the data base and alter the owner selections.

48. A system according to claim 47, wherein the royalty owner sets a view only password which permits a selected person entering that password to view selected information on the database.

49. A system according to according to any one of claims 40 to 48, including software to view or download the data on the administration database in a spreadsheet (TAB) or Acrobat® (PDF) format.
